(19) United States
(12) Patent Application Publication
(10) Pub. No.: US 2016/0162594 A1
(43) Pub. Date: Jun. 9, 2016

(54) Updated Content Notification

(71) Applicant: International Business Machines Corporation, Armonk, NY (US)

(72) Inventors: Lisa Seacat DeLuca, Baltimore, MD (US); Geetika T. Lakshmanan, Winchester, MA (US); Dana L. Price, Cary, NC (US); Shelbee D. Smith-Eigenbrode, Thornton, CO (US)

(21) Appl. No.: 14/562,513

(22) Filed: Dec. 5, 2014

(51) Int. Cl. G06F 17/30; G06F 17/27; G06F 17/22

(52) U.S. Cl. CPC G06F 17/30882; G06F 17/2235; G06F 17/27; G06F 17/2288

(57) ABSTRACT

Methods and computer program products relate to identifying content changes for a link since a previous access including storing information about accessed content by a user for a link, retrieving a current version of information about current content for the link, and determining content change by comparing the current version of the information about current content to information about last accessed content.

### BACKGROUND

Embodiments of the present invention generally relate to updated content notification. More particularly, embodiments relate to determining when updated content for a link exists and displaying indicia of updated content when presenting a document that contains references to the link's content.

Using hypertext, a link is a selectable connection from one word, picture, or information object to another. When a user views content that contains links to other content, content that has been visited in the past is typically displayed in a different format. For example, the link is displayed in a different color than links for content that the user has not visited. Under such an approach, however, the user may not know if the content residing at that link has been updated since the last time the user visited the content. Although developers may sometimes hardcode onto a page an indication that the content at that link is new (e.g., through “New” text, a badge or an icon), the user may have already visited the content and viewed the new content subsequent to the indication being hardcoded onto the page, thus it is not actually new to the user.

### BRIEF SUMMARY

Embodiments may include a method to identify content changes for a link since a previous access including storing information about accessed content by a user for a link, retrieving a current version of information about current content for the link, and determining content change by comparing the current version of the information about current content to information about last accessed content.

Embodiments may also include a computer program product to identify content changes for a link since a previous access, the computer program product including a computer readable storage medium having program instructions embodied therewith, the program instructions executable by a computer to cause the computer to store information about accessed content by a user for a link to form a last accessed information about the accessed content, retrieve a current version of information about current content for the link, and determine content change by comparing the current version of the information about current content to the last accessed information about accessed content.

Embodiments may also include a computer program product to identify content changes for a link since a previous access, the computer program product including a computer readable storage medium having program instructions embodied therewith, the program instructions executable by a computer to cause the computer to store metadata about accessed content by a user for a link to form a last accessed metadata about the accessed content associated with the link, retrieve a current version of metadata about current content for the link, determine content change by comparing the current version of the metadata about current content to the last accessed metadata about accessed content, and associate an html pseudo-class to the link element to specify that the state of an element has updated.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a block diagram of an example of a method of determining content change according to an embodiment;

FIG. 2 is an illustration of an example of a display according to an embodiment; and

FIG. 3 is a block diagram of an example of a computing system according to an embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

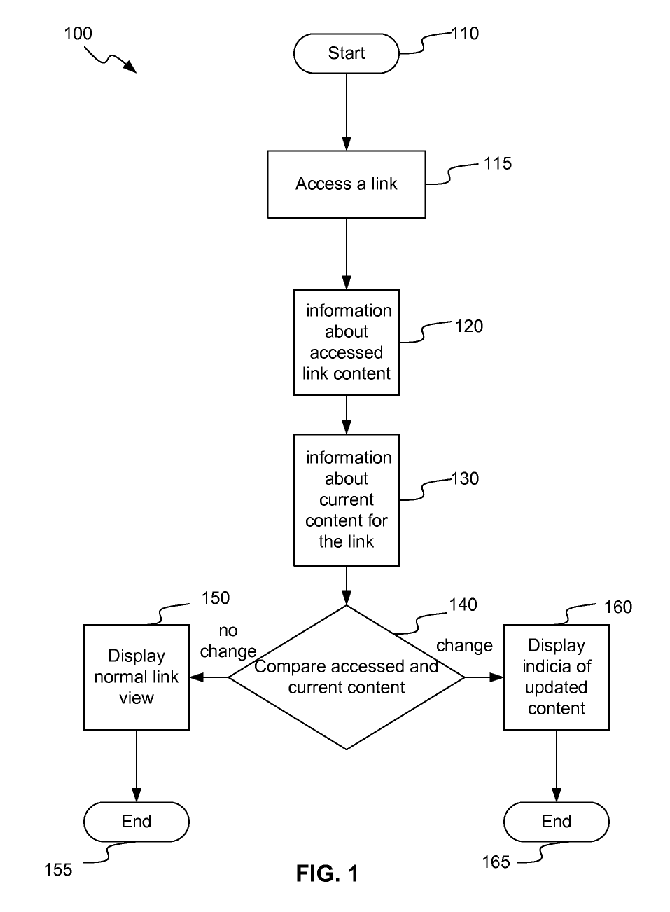

Turning now to FIG. 1, a method 100 of comparing content between a previously-accessed link and the link's current content is shown. The method 100 may be performed using a browser, a browser plug-in or any other tool that can perform the link comparison. Block 110 indicates the start. At block 110, a user may, for example, access a document that may include links. Such documents may include web pages, applications, results of a search query, or any other text or image that may include a link. For results of a search query, it is noted that a search may be entered into a browser or any other type of search tool such as an editor or a collaboration service.

The user may choose whether or not to visit a particular link found in the accessed document. If the user decides to access a link in block 115, he or she typically clicks on the link and is taken to a webpage. At this time, information about the current state of the page may be recorded on either a client or a server at block 120. It may be optionally cached for later retrieval. Alternatively, metadata about the last update/change to the webpage may be saved.

At some later time, the user may view another document that displays a reference to the same link as the previously-visited link. At this point, the page content may be examined with respect to either the saved page content or the metadata regarding the page content at illustrated block 130.

In illustrated block 140, the current page content referenced by the link is compared to the previously stored information about the user's access of the page content. This may be done by comparing cached content or by comparing metadata from the current page against the metadata from the page when it was previously accessed (forming a “last accessed information” about the accessed content). If there is no change in content, the link may be displayed normally at block 150 with an end at block 155. If content has changed, the link may be displayed with indicia of updated content at block 160. If there is a change in content an html pseudo-class may be associated with the link to specify that the state of an element has updated. In this manner a software developer is able to access a state that the developer can use to style as the developer would for any other html element. Typical states include “active” and “visited.” The present embodiment would permit a new option of “updated” and developers would use this information to determine a display style or other aspects of the html element. As to be discussed in further detail below, indicia of updated content may include displaying the link in a different style or format, or with additional text, or with icons to indicate content change. The end occurs at illustrated block 165.

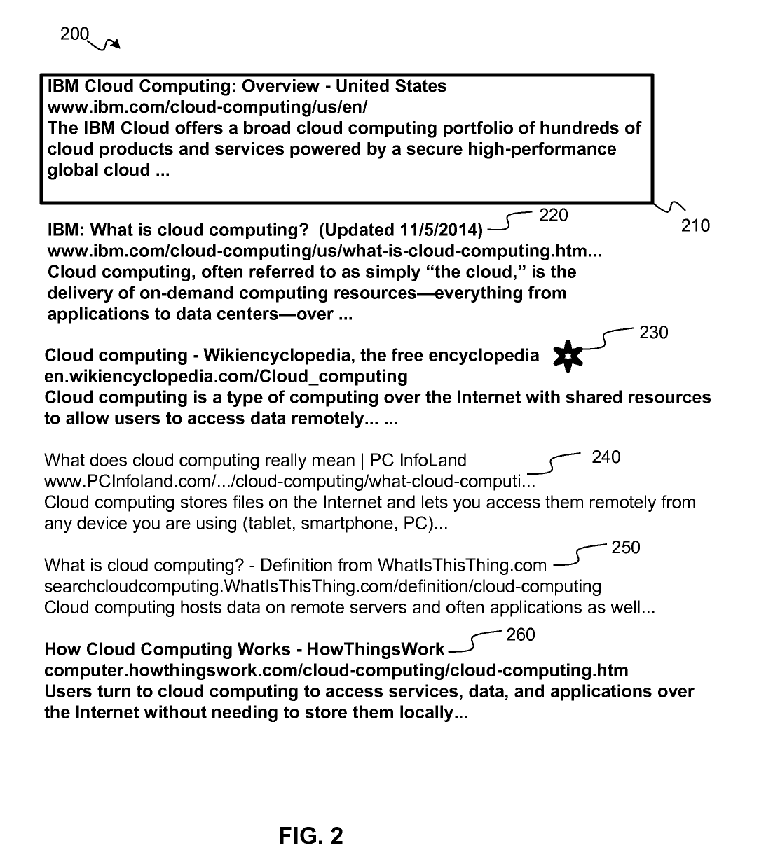

FIG. 2 depicts several embodiments of indicia that may be employed to indicate updated content for a previously-visited link. FIG. 2 depicts an example in which the user is viewing the results of a search query related to cloud computing; however, it is understood that the indicia may be used with any display of a link as in, for example, a web page, text, or in an image. In the results of the search query depicted, the links are URIs (Uniform Resource Indicators). In FIG. 2, the bold-faced displays (element numbers 210, 220, 230, and 260) represent links that have been visited previously by the user. Typically a browser will display these previously-visited links with a different color font that easily distinguishes the content already accessed by a user. According to the present embodiment, a user may be notified of updated content between a last access and the present display of the link. In element 210, a box may be displayed around the link with updated content. In element 220, the date of the updated content may be displayed. In element 230, a star may be used as an icon to indicate new content. In element 260, the lack of indicia indicates that no new content has been added since the user previously visited the link. Elements 240 and 250 show links that have not been previously visited by the user.

Additional features may be employed in other embodiments. For example, the user may customize the updated link information in various ways. In one aspect, the updated link information may be customized by the user to be applied only for certain links documents, certain web domains, certain time frames, or any other user customizable criteria. The last accessed information about the content may be discarded after a set period of time. In connection with web page programming, new content may be highlighted upon visiting a particular link. Further, the percentage or amount of updated content may be indicated to the user. A type of content, such as news or stock prices, to be determined or ignored as updated content for comparison to previously accessed content is also selectable by the user.

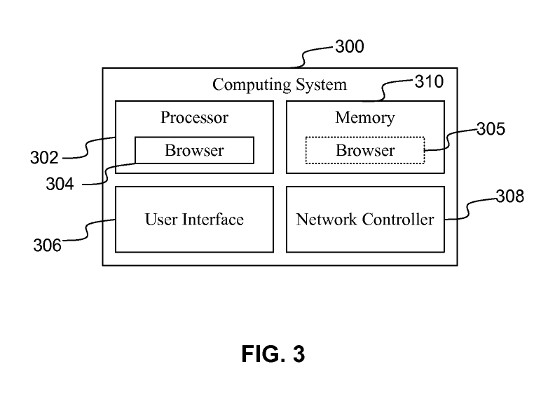

FIG. 3 shows a computing system 300 that may be used to indicate updated content as described herein. In the illustrated example, the computing system 300 includes a processor 302 that executes a browser 304 configured to implement one or more aspects of the method 100 (FIG. 1), already discussed. The computing system 300 further includes memory 310 (e.g., non-volatile memory/NVM, volatile memory) optionally including one or more of local and remote memory. A portion of the memory 310 may be devoted to storing a browser and actions associated with a browser, indicated at 305. In one example, the processor 302 obtains the browser 304 from the memory 310 Thus, the browser memory portion 305 may store information/metadata about accessed content by a user for a link visited by a user via user interface 306 (e.g., from accessing a first document such as search results, text, image, application, or web page, etc. through the user interface).

Through the user interface 306 and browser 304 the user may access a second document, such as search results, text, image, or web page that may include the same link as had been previously viewed in connection with the first document access. The browser 304 may retrieve a current version of information about current content for the link.

A network controller 308 may determine content change by comparing the current version of the information about current content to information about last accessed content stored at browser memory portion 305 or at a remote memory location. Information regarding content change may be indicated to the user through the user interface 306.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer program product to identify content changes for a link since a previous access, the computer program product comprising a computer readable storage medium having program instructions embodied therewith, the program instructions executable by a computer to cause the computer to:
store metadata about accessed content by a user for a link to form a last accessed metadata about the accessed content associated with the link;
retrieve a current version of metadata about current content for the link;
determine content change by comparing the current version of the metadata about current content to the last accessed metadata about accessed content;
associate an html pseudo-class to a link element to specify that a state of the link element has updated.

2. The computer program product of claim 1, wherein the program instructions are executable to cause the computer to display information about the date of content change when displaying the link.

3. The computer program product of claim 1, wherein the program instructions are executable to cause the computer to display information about an amount of content change when displaying the link.

4. The computer program product of claim 1, wherein the program instructions are executable to cause the computer to discard the last accessed metadata about the content after a set period of time.

5. A method to identify content changes for a link since a previous access comprising:
storing information about accessed content by a user for a visited link;
retrieving a current version of information about current content for the link;
determining content change by comparing the current version of the information about current content to information about last accessed content.

6. The method of claim 5, further comprising displaying an indication of content change when displaying the link.

7. The method of claim 6, further comprising displaying information about a date of content change when displaying the link.

8. The method of claim 6, further comprising displaying information about an amount of content change when displaying the link.

9. The method of claim 6, further comprising displaying the link in a different style or format, or with additional text, or with icons to indicate content change.

10. The method of claim 5, further comprising discarding information about the last accessed content after a set period of time.

11. The method of claim 5, wherein a type of content change to be determined is selectable by the user.

12. The method of claim 5, further comprising accessing content from a browser, an editor, or a collaboration service.

13. A computer program product to identify content changes for a link since a previous access, the computer program product comprising a computer readable storage medium having program instructions embodied therewith, the program instructions executable by a computer to cause the computer to:
store information about accessed content by a user for a link to form a last accessed information about the accessed content;
retrieve a current version of information about current content for the link;
determine content change by comparing the current version of the information about current content to the last accessed information about accessed content.

14. The method of claim 13, further comprising displaying an indication of content change when displaying the link.

15. The method of claim 14, further comprising displaying information about a date of content change when displaying the link.

16. The method of claim 14, further comprising displaying information about an amount of content change when displaying the link.

17. The method of claim 14, further comprising displaying the link in a different style or format, or with additional text, or with icons to indicate content change.

18. The method of claim 13, further comprising discarding the last accessed information about the content after a set period of time.

19. The method of claim 13, wherein a type of content change to be determined is selectable by the user.

20. The method of claim 13, further comprising accessing content from a browser, an editor, or a collaboration service.
